(19) United States
(12) Patent Application Publication
(10) Pub. No.: US 2023/0327093 A1
(43) Pub. Date: Oct. 12, 2023

(54) LITHIUM ALLOY BASED ANODE FOR NON-AQUEOUS AMMONIA PRIMARY AND RESERVE BATTERIES

(71) Applicants: Lin-Shu Du, Lansdale, PA (US); Art Driedger, Spring City, PA (US); Chao Shen, Hatfield, PA (US); Brendan Hayest-Oberst, West Chester, PA (US); Giuseppe L. Di Benetto, Nutley, NJ (US); Jeff Swank, Elysburg, PA (US); William J. Eppley, Skippack, PA (US); Kevin Vriarte, Pottstown, PA (US)

(72) Inventors: Lin-Shu Du, Lansdale, PA (US); Art Driedger, Spring City, PA (US); Chao Shen, Hatfield, PA (US); Brendan Hayest-Oberst, West Chester, PA (US); Giuseppe L. Di Benetto, Nutley, NJ (US); Jeff Swank, Elysburg, PA (US); William J. Eppley, Skippack, PA (US); Kevin Vriarte, Pottstown, PA (US)

(21) Appl. No.: 17/803,259

(22) Filed: Apr. 7, 2022

(51) Int. Cl. H01M 4/40; H01M 4/62; H01M 50/429; H01M 50/414; H01M 50/437; H01M 10/0568

(52) U.S. Cl. CPC H01M 4/405; H01M 4/625; H01M 50/4295; H01M 50/414; H01M 50/437; H01M 10/0568

(57) ABSTRACT

Novel lithium alloy anodes compatible with non-aqueous ammonia based electrolytes are described therein. Said anodes are supporting higher voltage and permit the use of ammonia electrolyte with broad range of salt concentrations, which results in low cost, fast response time and high power density batteries over prior art. Various cathodes, separators and cell constructions are also disclosed.

### BACKGROUND OF THE INVENTION

### Field of the Invention

This invention relates to low temperature, high power primary and reserve batteries having lithium alloy anode and ammonia based electrolyte.

These batteries have higher cell voltage output and higher power density at low temperatures than existing ammonia based batteries, due to the use of lithium alloy anode instead of prior art anode—magnesium. The Li alloy anode provides better compatibility with ammonia electrolyte and better storage life when compared to lithium metal anode. The Lithium alloy based batteries provide faster response time at low temperature when compared to lithium based batteries.

### Description of the Prior Art

It has been recognized that there is a need for higher energy density and high power batteries, working at very low temperature, and having extremely fast activation (response) time (10-300 ms).

Prior art ammonia based batteries have magnesium as the anode and meta-dinitrobenzene as the cathode, resulting in 2 V cell voltage and having relatively low power output, and thus larger and more cells are needed in a final battery assembly. Due to corrosiveness of the ammonia electrolyte, practical applications are limited to reserve batteries. Low viscosity of liquid ammonia at low temperature (for example, −0.35 cP at −55° C.) provides extremely fast activation time (10-300 ms).

In addition, due to the strong solvation ability of the nitrogen longer pair in the ammonia molecule, the conductivity of an ammonia based electrolyte is usually high over a wide temperature range. This allows ammonia based batteries to operate at high rate (>20 mA/cm²) at temperature ranging from −55 to +75° C. The development has shown that the 2 V cell voltage can be obtained via the use of meta-dinitrobenzene (m-DNB) cathode and Mg anode. There is a demand for miniature reserve battery applications, such as medium calibers, which requires low temperature and high rate operations with extremely fast activation at small footprint and higher cell voltage. Therefore, there is a need for improving ammonia based cell load voltage to be higher than 2 V.

One way to improve cell voltage is to identify cathode materials having higher redox potentials and compatible with ammonia based electrolyte.

Our patent application Ser. No. 17/300,205 shows, that by selecting cathode materials, the ammonia based cell load voltage can increase beyond 2.5 V.

The other way to improve the cell voltage is to replace magnesium by other electropositive metals having lower reduction potential.

Lithium has a lowest reduction potential and therefore using lithium as the anode should increase the cell operating voltage. However, like most of the alkali and alkaline earth metals, lithium dissolves in ammonia and forms ammonia solvated electron, so-called lithium blue.

The ammonia solvated electron is very reactive and can be dangerous when in contact with an oxidant such as cathode.

Our another patent application Ser. No. 17/300,843 shows that ammonia electrolyte with high salt concentration can suppress lithium blue formation and therefore the lithium anode based ammonia battery has been successfully developed with cell load voltage increased beyond 2.8 V.

Although the use of lithium metal as the anode can greatly improve the load voltage, the moisture sensitive lithium requires extra care and cost in battery production.

The use of lithium metal requires ammonia electrolyte with very high salt concentration, which increases the material cost.

The use of ammonia electrolytes with high salt concentration could slow down the activation time due to the relatively high viscosities especially at extremely low temperatures, such as −40° C.

The storage of a high salt concentration ammonia electrolyte in a container such as a glass ampoule requires sophisticated filling and sealing processes, which increases the production cost.

The storage life of lithium metal based ammonia battery may be limited by the high moisture sensitivity of lithium metal.

Prior art ammonium based batteries are described in the U.S. Pat. Nos. 3,445,295, 3,082,284 and 3,943,001, as examples.

Instant invention solves the above problems and provides high power, low temperature ammonia based batteries with fast response time.

### SUMMARY OF THE INVENTION

It has now been found that the use of lithium alloy anode can provide cell operating voltage as good as lithium metal and higher than the cell made with magnesium anode.

It has been also found that:

The handling of lithium alloying anode instead of plain lithium metal anode permits a relatively higher moisture condition which will reduce the production cost.

The use of lithium metal alloying anode permits the use of ammonia electrolyte with salt concentration lower than the one needed for plain lithium anode, which will reduce the material cost.

The use of lithium alloying anode instead of plain lithium metal anode provides longer storage life.

The use of lower salt concentration electrolyte can reduce the activation time especially at low temperatures and thus improve the response time of the battery. The use of lithium alloy anode provides high load voltages and reduce number of cells in a battery.

The benefits of high voltages also include the decrease of battery size and reduction of inter cell leakage, and increased power output of the battery.

The high voltage is possible by using lithium alloy anode and ammonia based electrolyte with at least one salt from the group including LiPF₆, LiBF₄, LiSCN, NH₄SCN, KSCN and LiNO₃.

Ammonia based primary and reserve batteries of the invention comprise: Li alloy based anode(s), in contact with a tabbed current collector; a cathode(s) being reduced upon discharge, such as a persulfate based salt like (NH₄)₂S₂O₈, or K₂S₂O₈, or Na₂S₂O₈, coated on and in contact with stainless steel current collector; a separator between the anode and cathode, such as 90% porous glass non-woven paper; and an electrolyte, such as ammonia NH₃ with a salt, such as KSCN, in a separate pressure ampoule.

The electrolyte salt can be stored in the separator and the cathode to speed up the wetting process. In this case pure NH₃ can be used for activation.

Normally, the battery is in a sealed housing and is stored dry, and is activated by the electrolyte by mechanically punching the wall of the ampoule, which is placed next to the battery. The activation is done only when the battery is needed to power a device. The battery may be multi-celled.

The above cathodes may be coated on a current collector by well known various methods via a slurry, comprising the active material, plastic binder and conductive carbon powder in a solvent, which solvent evaporates after coating.

The persulfate cathodes may be also replaced by a dinitrobenzene based cathode, permanganate based cathode, or by molybdenum oxide based cathode.

The principal object of the invention is to provide low cost, long storage life, low temperature capable, high energy and power ammonia electrolyte based battery with fast response time (rise time), having higher load voltage and thus fewer cells over prior art, and thus reducing the size and cost of the battery assembly.

A further object of the invention is to provide Li alloy anodes for better compatibility between anode and the ammonia electrolyte and therefore lower salt concentration electrolyte can be used for better battery activation/response time. The Li alloy anode based battery also provide better storage life and lower production cost when compared to the pure lithium based battery.

Another object of the invention is to provide high power density ammonia based battery that can operate at low temperatures for the military.

Other objects and advantages of the invention will be apparent from the description and claims.

### BRIEF DESCRIPTION OF THE DRAWINGS

The nature and characteristic features of the invention will be more readily understood from the following description taken in connection with the accompanying drawing forming part thereof, in which:

FIG. 1 is a sectional side elevational view of cylindrical ammonia based primary or reserve battery, having flat circular electrodes and the electrolyte in the ampoule placed on top of the cells.

FIG. 2 includes the images of glass containers having lithium metal or lithium alloys in 6% (top) or 17% (bottom) KSCN/NH₃ solution. The alloys are labelled in the form LixMgy indicating the alloy composition having x % Li and y % Mg (by mass). The images related to lithium metal were taken within 2-3 seconds after the solutions were in contact with lithium. The images related to lithium alloys were taken about 240 seconds after the solutions were in contact with the alloys. The dark color in glass containers indicates the formation of lithium blue. The bubble in glass containers suggests the presence of side reactions.

FIG. 3 is a discharge time (first 100 seconds) versus voltage diagram for cells made with ammonia persulfate cathodes and anodes including Mg, Li and Li50Mg50 alloy (containing 50 weight % Li and 50 weight % Mg), activated with ammonia electrolyte having 22% KSCN, and discharged at 40 mA/cm².

FIG. 4 is a discharge time (first 100 seconds) versus voltage diagram for cells made with ammonia persulfate cathodes and anodes including Mg and Li30Mg70 alloy (containing 30 weight % Li and 70 weight % Mg), activated with ammonia electrolyte having 6% KSCN, and discharged at 40 mA/cm².

FIG. 5 is a discharge time (first 100 milliseconds) versus voltage diagram, comparing rise time between the lithium containing cell and the Li30Mg70 containing cell, both of which were made with ammonia persulfate cathodes. The lithium and the Li30Mg70 cells were activated with ammonia electrolyte having 6 and 55% KSCN, respectively, and discharged at 40 mA/cm² at −40° C.

It should, of course, be understood that the description and drawings herein are merely illustrative, and that various modifications and changes can be made in the compositions and the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function substantially same way to bring about the same results.

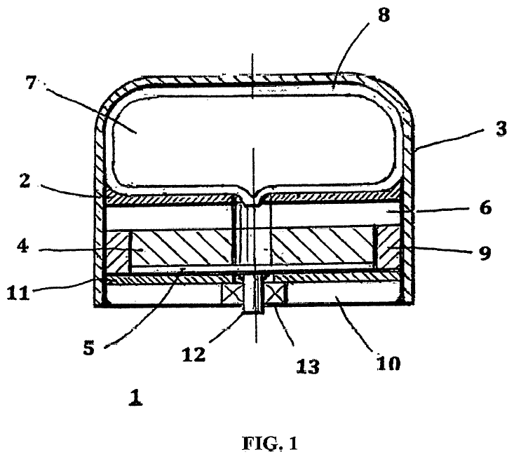

Referring now to the FIG. 1, which is one embodiment of the invention, showing ammonium based low temperature primary or reserve battery 1 of the invention, as an example, which battery comprises a lithium alloy anode 2; in contact with a metal enclosure/current collector 3; a cathode 4, such as persulfate based salt like (NH₄)₂S₂O₈, or K₂S₂O₈, or Na₂S₂O₈, coated on a tabbed stainless steel collector 5 and in contact with the cathode 4; a separator 6, such as 90% porous non-woven glass paper, between said anode 2 and cathode 4; and an electrolyte 7, such as ammonia NH₃ with a salt like KSCN dissolved therein, and the electrolyte is stored in a separate pressure ampoule 8, preferably of a glass material, placed next to the battery components 2 to 6. The cathode 4 with collector 5 is insulated by non-conductive ring 9.

The battery 1 is sealed dry in moisture-proof metal enclosure 3, with metal plug 10, insulating layer 11, and positive metal pin 12, welded to the collector 5 and sealed by glass seal 13. The battery 1 is activated by mechanically punching the wall of the ampoule 8. The activation is done only when the battery 1 is needed to power a device.

The battery may be multi-celled with the cells connected in parallel. (not shown). All structures are heat and pressure and corrosion resistant.

Other cells' constrictions may be also used with the anode of the invention, as described in our prior patent application Ser. No. 17/300,843, and in prior art PAT. Nos. 3,45,295; 3,032,284 and 3,943,001, which are hereby incorporated by reference. The lithium alloy anodes in the described batteries of the invention are composed of alloys of lithium with alkali or alkaline earth metals, such as sodium, potassium, rubidium, caesium, magnesium and calcium.

Such alloys may contain 2 to 98 weight percent of lithium in the alloy.

The lithium alloy anodes above may also contain elements of 111A group in the periodic table, such as boron, aluminum, gallium and indium; and elements of IVA group in the periodic table, such as carbon, silicon, germanium, tin and lead; and elements of VA group in the periodic table, such as antimony and bismuth; and elements of transition metals in the periodic table, such as copper, silver, gold, zinc, cadmium, mercury, titanium, zirconium, vanadium and niobium. The lithium alloy anodes above may also contain a combination of elements listed above.

The cathodes 4 described in FIG. 1 may be coated on the collector 5 by well known various methods via a slurry comprising the active material, plastic binder, and conductive carbon powder in a solvent, which solvent evaporates after coating. Additionally, the described material persulfate salt of the cathode 4 may be replaced by molybdenum oxide, permanganate, meta-dinitrobenzene, or their mixtures.

The battery electrolyte of the invention is ammonia-based non-aqueous electrolyte, and comprises NH₃ solvent with at least one salt selected from the group including: LiPF₆, LiBF₄, LiTFSI, LiSCN, NH₄SCN, KSCN and LiNO₃, dissolved therein.

The cathode's persulfate salt of the invention has a general structure represented by the formula: X₂S₂O₈, wherein X is representative of a cation with an ionic charge 1+(such as Li⁺, Na⁺, K⁺, NH₄⁺) with associated anion of S₂O₈²⁻.

The separators in the described batteries of the invention may be also made from a porous polymer or a solid state ion conductive film.

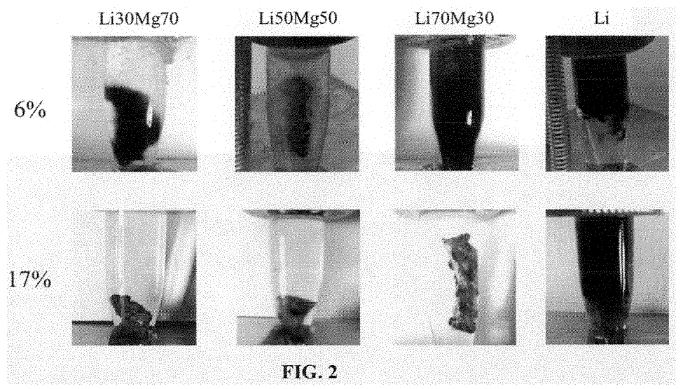

FIG. 2 shows that the dark blue solution (so-called Li blue) forms within 2-3 seconds when Li is in contact with 6% or 17% KSCN/NH₃ electrolytes. Less Li blue was observed when Li—Mg alloys (Li30Mg70, Li50Mg50 and Li70Mg30) were in contact with the electrolytes even after 240 seconds. The alloy with higher Mg content has better compatibility/stability to KSCN/NH₃ electrolyte with low salt concentrations.

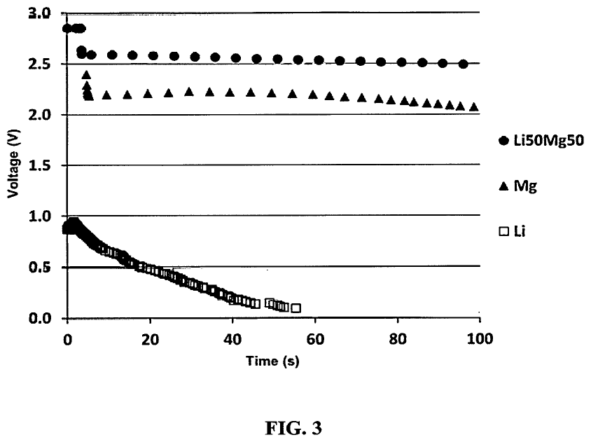

FIG. 3 demonstrates that the Li50Mg50 alloy containing cell has a higher load voltage than the Mg or the Li containing cell when the cell was activated with 22% KSCN/NH₃ electrolyte. Li containing cell does not perform well at 22% KSCN/NH₃ due to its poor anode-electrolyte stability.

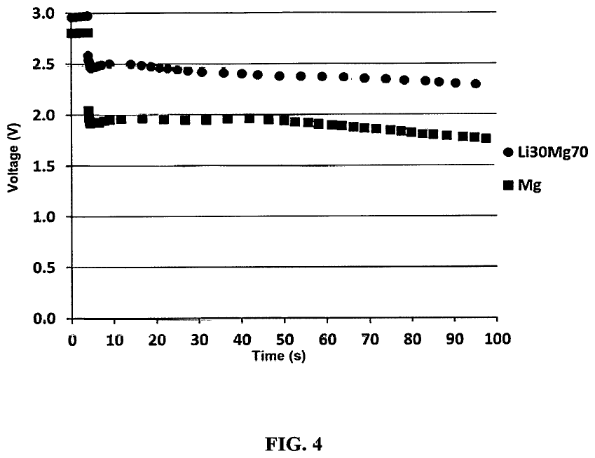

FIG. 4 indicates the use of Li30Mg70 alloy anode allows cell to run with a good performance even with low salt concentration electrolyte (such as 6% KSCN/NH₃). The alloy containing cell outperforms the Mg containing cell. The Li containing cell cannot run at this electrolyte condition.

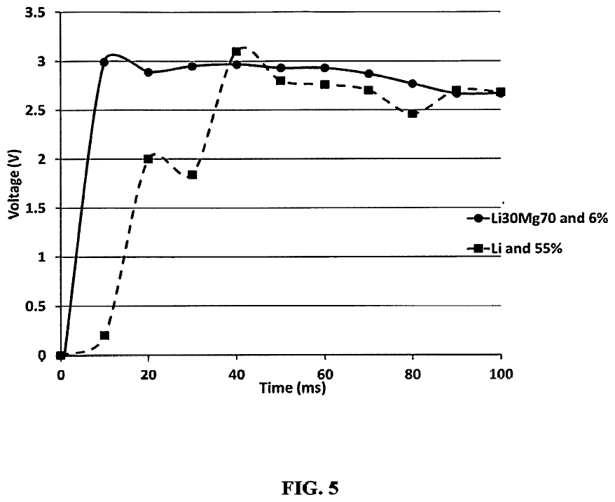

FIG. 5 shows rise time improvement when using Li alloy anode instead of Li anode. The cell with Li30Mg70 alloy anode activated with 6% KSCN/NH₃ electrolyte shows a shorter rise time than the cell with Li anode activated with 55% KSCN/NH₃ electrolyte.

The use of lithium alloys as the anode results in the anode electrolyte compatibility improvement when compared to plain lithium anode, and the load voltage enhancement when compared to magnesium anode.

The use of lithium alloys as anode also provides flexibility in chemistry and engineering designs, and much lower salt concentration electrolyte can be used. When a lithium alloy with high magnesium content is used (such as 70 by weight %), it provides a better rise time performance, longer cell storage time, and lower production cost.

It will thus be seen that when using the described lithium alloy anodes, high power density, better performance and design flexibility lithium based ammonia batteries have been provided with which the objects of the invention are achieved.

We claim:

1. A lithium alloy metal anode for ammonia electrolyte based reserve and primary batteries, comprising 2 to 98 weight percent Li in the alloy.

2. A lithium alloy as described in claim 1, in which said lithium is alloyed with an alkali metal(s), such as sodium, potassium, rubidium and caesium.

3. A lithium alloy as described in claim 1, in which said lithium is alloyed with an alkali earth metal(s), such as magnesium and calcium.

4. A lithium alloy as described in claim 1, in which lithium is alloyed with elements in IIIA group in the periodic table, such as boron, aluminum, gallium and Indium.

5. A lithium alloy as described in claim 1, in which lithium is alloyed with elements in IVA group in the periodic table, such as carbon, silicon, germanium, tin and lead.

6. A lithium alloy as described in claim 1, in which lithium is alloyed with elements in VA group in the periodic table, such as antimony and bismuth.

7. A lithium alloy as described in claim 1, in which lithium is alloyed with elements in transition metals in the periodic table, such as copper, silver, gold, zinc, cadmium, mercury, titanium, zirconium, vanadium and niobium.

8. A lithium alloy as described in claim 1, in which lithium is alloyed with combination of elements listed in claims 2 to 7.

9. A non-aqueous reserve and primary battery having ammonia based electrolyte, a lithium alloy based anode(s), a porous non-conductive separator(s) and a cathode(s), whose active material(s) is (are) selected from the group including a persulfate salt, manganese oxide, permanganate, meta-dinitrobenzene and their mixtures.

10. A non-aqueous reserve and primary battery as described in claim 9, in which said cathode active material is a persulfate salt, which has a general structure represented by the formula: X₂S₂O₈, wherein X is representative of a cation with an ionic charge 1+(such as Li⁺, Na⁺, K⁺, NH₄⁺) with associated anion of S₂O₈²⁻.

11. A non-aqueous battery as described in claim 9, in which said cathode active material with a binder and conductive carbon powder is coated on a conductive current collector.

12. A non-aqueous battery as described in claim 9, in which said cathode active material with a fibrous binder and carbon conductive powder included therein is in a pad form, and said pad is in contact with a conductive substrate material.

13. A non-aqueous battery as described in claim 9, in which said cathode active material with a binder and conductive carbon is in a free-standing form casted onto a conductive substrate material.

14. A non-aqueous battery as described in claim 9, in which said cathode active material with a binder and conductive carbon is pressed onto a conductive substrate material.

15. A non-aqueous reserve battery as described in claim 9, which battery has horizontally stacked flat circular electrodes.

16. A non-aqueous reserve battery as described in claim 9, which battery is in a cylindrical form having said cathode wound.

17. A non-aqueous battery as described in claim 9, in which battery said separator(s)' material is a porous glass non-woven paper.

18. A non-aqueous battery as described in claim 9, in which battery said separator(s)' material is a porous cellulose fiber paper.

19. A non-aqueous battery as described in claim 9, in which battery said separator(s)' material is a porous polymer film.

20. A non-aqueous battery as described in claim 9, in which battery said separator(s)' material is replaced by a solid state ion conducting material.

21. A lithium alloy anode as described in claim 3, in which said alloy anode contains 70% of magnesium.
